(19) United States
(12) Patent Application Publication
(10) Pub. No.: US 2008/0117921 A1
(43) Pub. Date: May 22, 2008

(54) Method And System For Presenting Command Information Associated With A Status

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/561,636

(22) Filed: Nov. 20, 2006

(51) Int. Cl. H04L 12/56

(52) U.S. Cl. 370/401; 370/389

(57) ABSTRACT

Accordingly, a method and system are disclosed for presenting command information associated with a status. According to an exemplary embodiment, the method includes associating a command with a status of a presentity for indicating a principal associated with the presentity can process the command when the presentity has the associated status. The method further includes determining a change in status associated with the presentity. The method also includes determining whether the changed status corresponds to the status associated with the command. The method further includes sending a status message to a client including a watcher via a presence service, the status message including the changed status of the presentity and command information related to the command when the changed status corresponds to the status associated with the command, allowing the client including the watcher to request the principal to process the command.

### BACKGROUND

Today's presence services provide status information to watchers as informational data. The status information is not intended to be instructive or constraining. For example, current instant messaging (IM) systems will allow a user to send an instant message to another IM user regardless of the other user's status. The intended recipient of the IM message does not need to be online for the sender to send the message. This is partly because applications that use presence information run independently from associated presence services. Instant messages use a different protocol, different proxies, and different clients (although IM clients are integrated with presence clients to provide an integrated user interface, the client's are separable).

While it's possible to build constraints into the client of the watcher or into the client of the publisher of the status, to do so would require each application to provide similar code (albeit with different command capabilities and constraints). Updating these capabilities for each application using presence services would be an even more challenging task.

In today's systems, a user is given no indication as to what commands a principal associated with a presentity can process. The user is given a status that indicates whether the principal associated with a presentity is online, in a meeting, etc. The user is not, however, given an indication as to a command the principal can process while in its current state. Accordingly, there is a need for a method and system for presenting command information associated with a status

### SUMMARY

Accordingly, a method and system are disclosed for presenting command information associated with a status. According to an exemplary embodiment, a method is described for presenting command information associated with a status. The method includes associating a command with a status of a presentity for indicating a principal associated with the presentity can process the command when the presentity has the associated status. The method further includes determining a change in status associated with the presentity. The method also includes determining whether the changed status corresponds to the status associated with the command. The method further includes sending a status message to a client including a watcher via a presence service, the status message including the changed status of the presentity and command information related to the command when the changed status corresponds to the status associated with the command, allowing the client including the watcher to request the principal to process the command.

According to another exemplary embodiment, a method is described for presenting command information associated with a status. The method includes transmitting a subscription request to a presence service, the subscription request for subscribing to a tuple associated with a presentity. The method also includes receiving a status message via the presence service in response to a change in status of the presentity, the status message including the changed status of the presentity and command information related to a command indicating a principal associated with the presentity can process the command. The method further includes transmitting a selection message including a selection of the command for the presentity to process.

According to another exemplary embodiment, a system is described for presenting command information associated with a status. The system includes a presentity associated with a presence service. The system also includes a service state manager configured to associate a command with a status of the presentity for indicating the principal associated with the presentity can process the command when the presentity has the associated status, determine a change in status of the presentity and determine whether the changed status corresponds to the status associated with the command. The presentity is associated with a principal and is configured to send presence information including a status. The presentity of the system is further configured to send a status message to a client including a watcher via a presence service, the status message including the changed status of the presentity and command information related to the command when the changed status corresponds to the status associated with the command, allowing the client including the watcher to request the principal to process the command.

According to another exemplary embodiment, a computer readable medium containing a computer program, executable by a machine, for presenting command information associated with a status is described. The computer program includes executable instructions for associating a command with a status of a presentity for indicating a principal associated with the presentity can process the command when the presentity has the associated status. The computer program includes instructions for determining a change in status associated with the presentity. The computer program includes instructions for determining whether the changed status corresponds to the status associated with the command. The computer program further includes instructions for sending a status message to a client including a watcher via a presence service, the status message including the changed status of the presentity and command information related to the command when the changed status corresponds to the status associated with the command, allowing the client including the watcher to request the principal to process the command.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for presenting command information associated with a status, according to an exemplary embodiment;

FIG. 2 illustrates a system for presenting command information associated with a status, according to an exemplary embodiment;

FIG. 3 illustrates a system for presenting command information associated with a status, according to an exemplary embodiment;

FIG. 4 illustrates an exemplary tuple structure supporting command information associated with status according to an exemplary embodiment;

FIG. 5 illustrates a system for presenting command information associated with a status, according to an exemplary embodiment;

FIG. 6 illustrates a system for presenting command information associated with a status, according to an exemplary embodiment; and

FIG. 7 is a message flow diagram illustrating a flow of information in presenting command information associated with a status, according to an exemplary embodiment.

### DETAILED DESCRIPTION

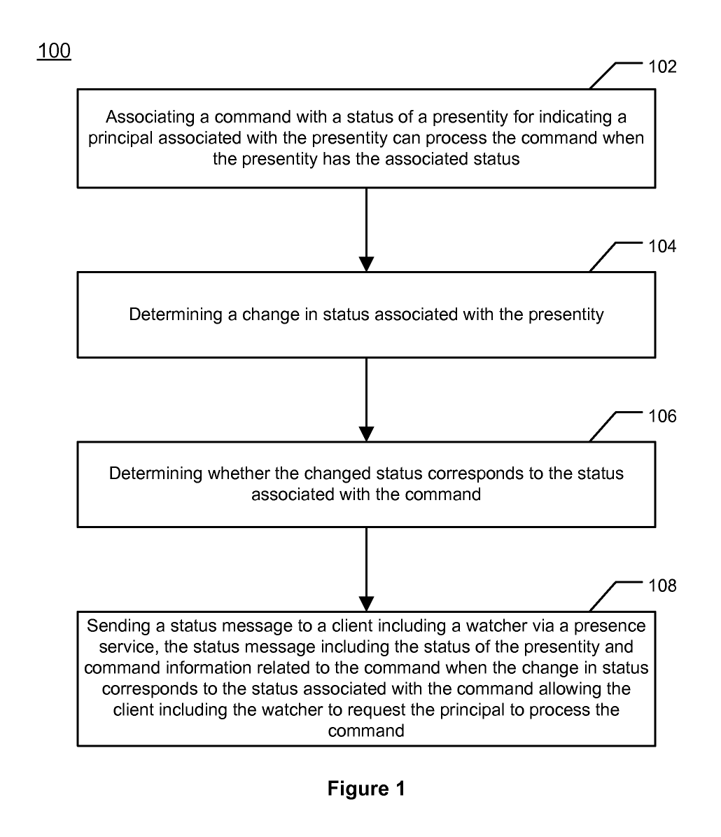

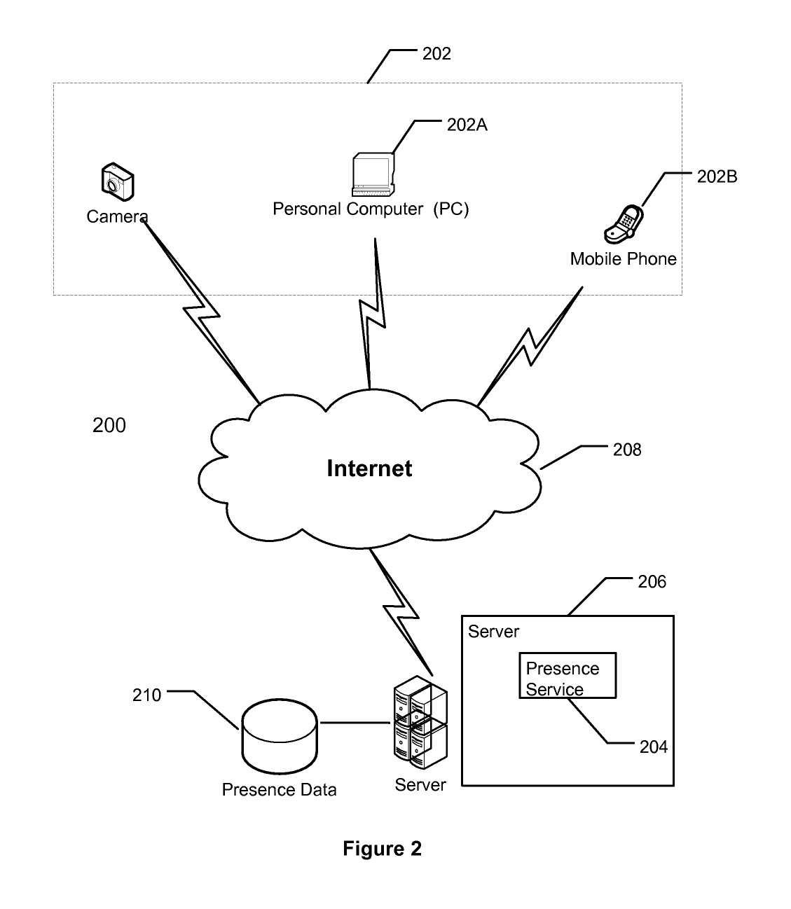

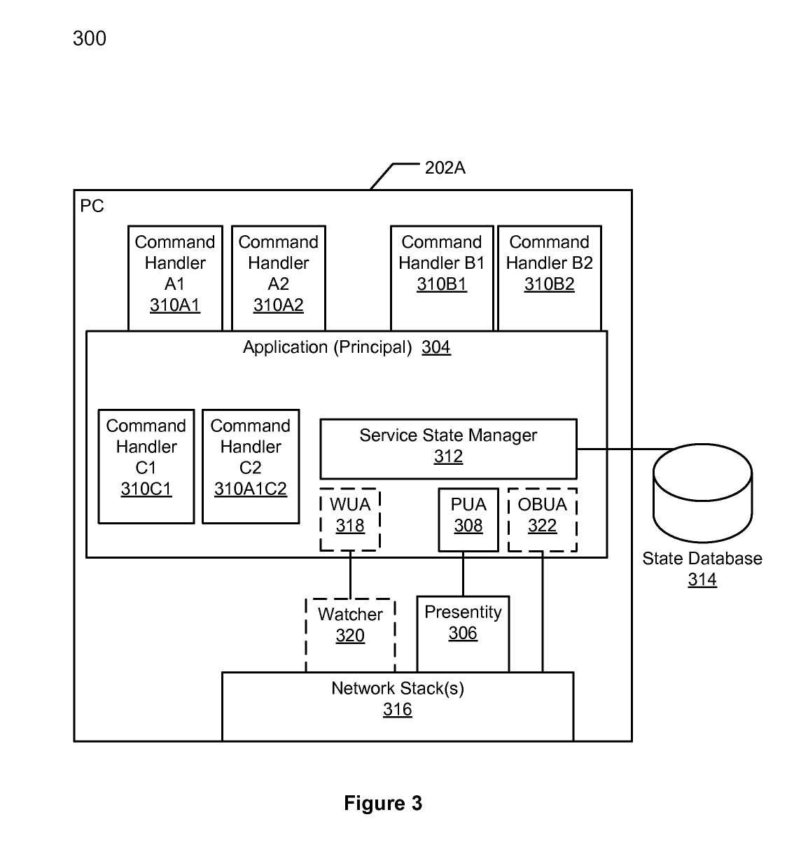

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. According to an exemplary embodiment, a method is described for presenting command information associated with a status. FIG. 1 depicts a flowchart illustrating an exemplary process 100 for presenting command information associated with a status. The process can be carried out using the exemplary systems depicted in FIG. 2 and FIG. 3, portions of which are referenced below for illustration purposes. A process 100 in FIG. 1 allows a client including a watcher to determine a command a principal of a watched presentity will process if requested given the principal's current state reported by the presentity in an exemplary embodiment. An embodiment is described that operates using an exemplary system 200, as depicted in FIG. 2. The system 200 includes a plurality of client devices 202 enabled to communicate with a presence service 204 running in a server 206 over a network such as the Internet 208. The presence service 204 uses a presence database 210 for storing presence tuple data including subscription data and friends lists. In an exemplary embodiment, the process is performed by a client device from the exemplary client devices 202. The system 300 depicted in FIG. 3 is an exemplary client device system enabled to carry out the steps of the process 100. The process 100 is described in terms of an embodiment using the components of the system 300 operating as one of a plurality of the client devices 202 in the system 200.

In block 102 of process 100, a command is associated with a status of a presentity for indicating a principal associated with the presentity can process the command when the presentity has the associated status. The presentity serves as an agent for a principal by, for example, providing the principal's current status to a presence service. An association of the command with a status of the presentity indicates that the principal associated with the presentity can process the command when the presentity status associated with the principal is the status associated with the command.

For example, in the exemplary embodiment depicted as a system 300 in FIG. 3, a client device shown as a personal computer (PC) 202A hosts an application 304. The application 304 is a principal associated with a presentity 306 via communication enabled via a presence user agent (PUA) 308. The application 304 is enabled to process one or more commands referenced collectively in FIG. 3 as 310. The application 304 includes a service state manager (SSM) 312. The SSM 312 is configured to associate a command with a status of a presentity 306 for indicating the principal 304 associated with the presentity 306 can process the command when the presentity 306 has the associated status.

In FIG. 3, the application 304 includes support for two internal command handlers, C1 310C1 and C2 310C2. In the embodiment described, the application's 304 command support is extendible through a plug-in interface allowing external command handlers to be registered with the application 304. This registration enables external command handlers to be operably coupled with the application 304. FIG. 3 depicts four external command handlers; A1 310A1, A2 310A2, B1 310B1, and B2 310B2. A command handler can support one or more commands known to the application 304 via registration or configuration including pre-configuration, which is typical for internal command handlers.

At least one of the command handlers 310 is capable of processing a command only under certain conditions. It should be noted that some command handlers 310 process multiple commands under certain conditions in an exemplary embodiment. As discussed above the application 304 includes the service state manager (SSM) 312. The SSM 312 is configured to track information detected and/or determined by the SSM 312 or communicated to the SSM 312 from the command handlers 310 or other components of the application 304. The SSM 312 uses the tracked information to determine state information including a plurality of possible states where state information sets are each associated with a status or status information.

Each command, in the described embodiment is associated with a status that indicates a state in which the principal, application 304, can process the command by invoking one of more command handlers 310. In an exemplary embodiment, commands and statuses may have any of a one-to-one relationship, a many-to-one relationship, a one-to-many relationship, and a many-to-many relationship. In system 300, the associations of commands with statuses are stored in state database 314. Additionally, state database 314 maintains an association of commands with command handlers 310. As discussed, in an exemplary embodiment, a plurality of commands is associated with the status of the presentity for indicating a principal associated with the presentity can process the plurality of commands when the presentity has the associated status.

In an embodiment, the process 100 includes receiving association information representing the association between the command and the status of the presentity; and updating the association between the command and the status according to the association information if an association exists, or establishing the association of the command with the status according to the association information, if one does not.

For example, the SSM 312 is configured to receive association information representing the association between the command and the status of the presentity. The SSM 312 is configured to determine if a preexisting association between the command and status exist. This determination is made via a query to the state database 314. If a preexisting association does not exist, then the SSM 312 is configured to establish the association and save it in state database 314. If a preexisting association does exist, then the SSM 312 is configured to update the association in state database 314.

In block 104 of process 100 depicted in FIG. 1, a change in status (e.g., from a first status to a second status) associated with the presentity is determined. The determination is made by the presentity and/or a presence service upon receiving a status update message from the presentity depending upon the embodiment.

For example, the current status of the application 304 as determined by the SSM 312 is communicated to the PUA 308 upon a change in status to the presentity 306. The presentity 306 performs its role as described in Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society, by generating presence information including status information based on the status received from the PUA 308. In an exemplary embodiment, the presentity 306 sends a publish command via the network stack 316 including a presence protocol layer (not shown) over the Internet 208 to the presence service 204. The presence service 204 updates a tuple associated with the presentity 306, thereby associating the status information in the tuple with the presentity 306 as the presentity's 306 current status.

The presentity 306 generates presence information associated with the principal that in system 300 is application 304. The presence information includes status information based on the status received from the PUA 308 as provided by the SSM 312. In the exemplary embodiment, the presentity 306 publishes the presence information via the Internet 208 to the presence service 204 hosted by the server 206. Thus, the statuses of the application 304 as reported by the presentity 306 are associated with the presentity 306 by the presence service 204 via a tuple stored in presence database 210.

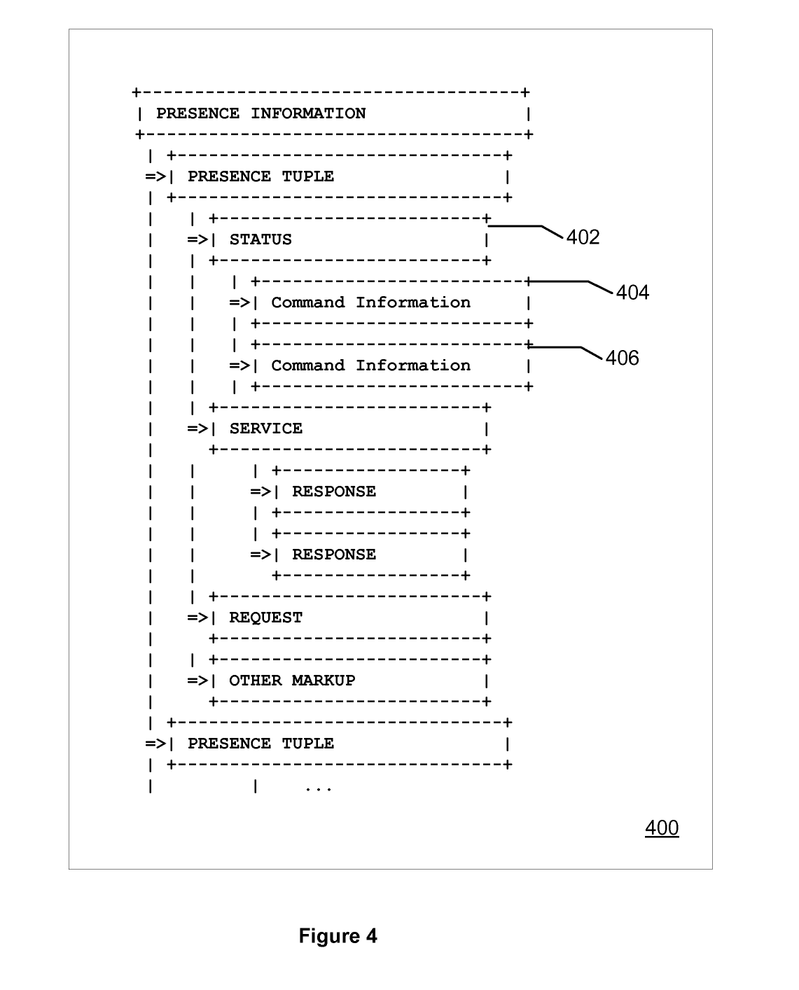

An exemplary tuple 400 is illustrated in FIG. 4. The exemplary tuple 400 includes a status 402. The exemplary tuple 400 further includes two commands 404 and 406 associated with the status 402. In this example, the commands and the status have a many to one relationship. As discussed above, commands and statuses may have any of a one-to-one relationship, a many-to-one relationship, a one-to-many relationship, and a many-to-many relationship.

In the exemplary system 300, a change in status is determined from tracked information by the SSM 312. The change, for example, is the result of command processing by a command handler 310, an internal event of the application 304, and/or an input received via a network input such as a notification received via an optional watcher user agent (WUA) 318 and watcher 320, another executable (not shown), and/or via user input (not shown). The SSM 312 associates the changed status with the presentity 306 acting as the application's 304 agent for the presence service 204.

In block 106 of process 100 depicted in FIG. 1, the process determines whether the second status corresponds to a status that is associated with the command. As described above, the process has associated a command with a particular status. Once, the status has changed to a new status (e.g., the second status), the process must determine if the second status is associated with a command.

For example, in the system 300, the SSM 312 is configured to query the command association data in the state database 314 to determine whether any commands are associated with the new status. Any commands associated with the new status are now operable given the change in status. When an associated command is found, the SSM 312 is configured to pass command information to the presentity 306 via the PUA 308 in addition to the changed status information.

In block 108 of process 100 depicted in FIG. 1, the process sends a status message to a client including a watcher via a presence service. The status message includes the status of the presentity and command information related to the command when the change in status corresponds to the status associated with the command allowing the client including the watcher to request the principal to process the command. In an embodiment, the watcher which is a subscriber to the presentity's tuple or, alternatively, is identified in the publish command as a recipient causing the presence service to send a directed notification. The status information and associated command information received by a watcher allows the client including the watcher to request the principal associated with the presentity to process the command. In an embodiment, sending the status message is accomplished by sending a directed notification to the client including the watcher. In an embodiment, the status message includes form information for presenting a form to a principal associated with the client including the watcher, the form for receiving parameters associated with the principal.

For example, in the system 300 the SSM 312 is configured to use the command association data in the state database 314 to determine commands operable given the change in status. The SSM 312 provides the changed state information and the associated command information to the PUA 308 for passing to the presentity 306 via a presence service 204.

In an exemplary embodiment having a plurality of commands associated with the status, the SSM 312 is configured to select one of the plurality of commands associated with the status of the presentity 306 according to the identification information of, for example, the mobile phone 202B including a watcher to include command information related to the selected command in the status message.

In an embodiment, the command information includes a variety of information related to commands. For example, the command information includes constraint information for restricting commands not associated with the status of the presentity 306 from being processed. This prevents an inoperable command from being requested of the principal 304. In another example, the command information includes information for a command associated with the status that is a deactivating command for deactivating the principal 304 associated with the presentity 306. Thus, the principal 304 could be deactivated by the mobile phone 202B including the watcher.

In another example the command information includes information for a command that includes a configuration command for allowing the principal 304 associated with the presentity 306 to be configured. This allows the mobile phone 202B including the watcher to configure the principal 304 via the exemplary system and method. In some embodiments, the command information includes commands that the mobile phone 202B including the watcher initiates using means other than the presence system. In another example, the command information includes authorization/access information providing permission to request a command and have it processed. The authorization/access information is generated automatically, in various embodiments, by the presence or other proxy server and/or by the publishing client. The authorization/access information in some implementations is temporary with time or number of uses restrictions, for example.

In an embodiment, the command information is customized according to at least one of the mobile phone 202B including the watcher and the principal 304. For example, if the publishing principal 304 is a device or service supporting a plurality of access roles, the command information is sent to each watching client based on each client's role (e.g., admin, user, guest, etc). If the watcher's principal is a device or machine, it is sent command information it understands. Specific device to device command protocols are provided this way as depicted by an out-of-band user agent (OBUA) 322 in FIG. 3. In an embodiment, this customization of command information is performed using information including command information and watching client information

In an embodiment, process 100 includes receiving a request including selection information representing a selection of a command for processing. In this embodiment process 100 includes processing the command according to the selection information.

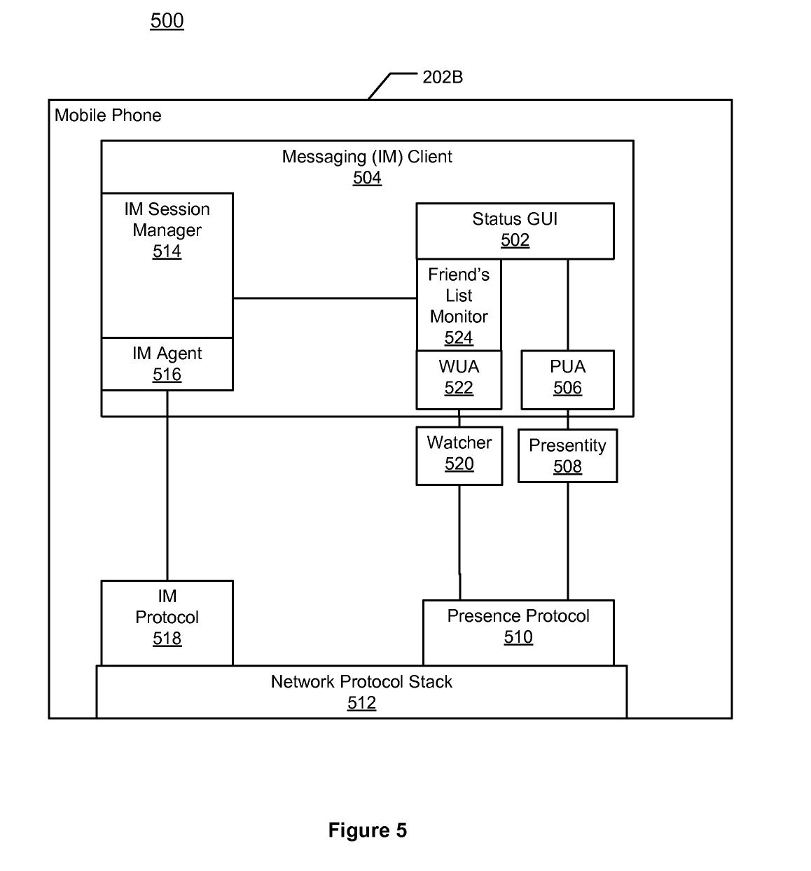

For example, an exemplary embodiment illustrated in FIG. 5 allows a principal of a watcher included in the mobile phone 202B to select a widget or control associated with a command via a status GUI 502 of a messaging client 504. The command information of the command associated with the widget is received, typically in a notify message from the presence service 204. Upon receiving the selection, the status GUI 502 then generates a request including the command, and sends the command to the associated principal. In system 500, the status GUI 502 sends the request including the command using the presence system. That is, the request is sent to a PUA 506, which communicates the command information to a presentity 508 of the messaging client 504. The presentity 508 builds a message including the command information and sends it to the presence service 204 using, in an embodiment, a presence protocol 510 layer coupled to a network protocol stack 512. The message is typically sent using a publish command or a directed publish command.

The presence service 204 sends a representation of the command information to the system 300, which receives the command information in a message via its network stack 316. In, another exemplary embodiment, the system 500 receives a command selection. The messaging client 504 sends a request including command information to the associated principal using an instant messaging protocol (components 514, 516, and 518 in system 500).

In an exemplary embodiment, the command information sent using a presence protocol as described is passed by the network stack 316 to a watcher 320 (shown as an optional component in the system 300), which parses the message and sends a representation of the command information to a watcher user agent (WUA) 318. The service state manager 312 receives the command information from the WUA 318 and routes the command information to the command handler 310 if the current status is compatible with the received command as indicated by the association information in the state database 314. The command is then processed by the receiving command handler 310. If a response is required, the response, in an embodiment, is sent as a publish command to the presence service 204 in a manner analogous to that described for publishing presence information including status and command information previously described.

In an embodiment illustrated as system 500 in FIG. 5, the presence service 204 sends a message to a watcher include in the mobile phone 202B. The mobile phone 202B including the watcher receives the message via its network protocol stack 512 from the Internet 208. At least a portion of the message is passed to the presence protocol 510 layer configured to provide support for the application layer presence protocol used by the client devices 202 and the presence server 204 in the system 200.

As the message is a notification in this embodiment, a representation of the message is passed to the watcher 520. The watcher 520 serves as an agent for the principal of the messaging client 504. The watcher 520 communicates the message including status information and command information to the messaging client 504 via the client's watcher user agent (WUA) 522. In the described embodiment, a friends list monitor 524 receives the message information from the WUA 522. The friends list monitor 524 manages subscriptions and processes notifications. The friends list monitor 524 interoperates with the status GUI 502 to provide at least a portion of the message information to enable the status GUI 502 to present the current information.

In the embodiment described, the status GUI 502 displays status information associated with each friend and additionally is enabled to display command information associated with a status of a principal of a watched presentity. The command information provides a user (e.g. principal) of the messaging client 504 with information concerning commands that are processable by the principal of the watched presentity while the principal is in its current status.

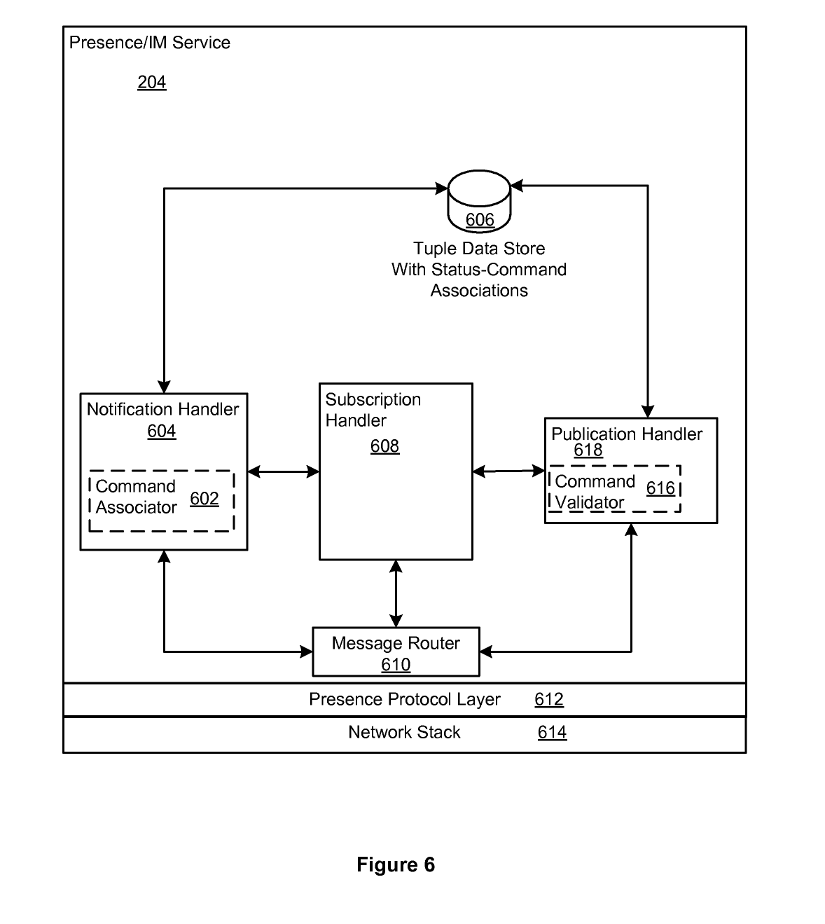

In an alternative embodiment, rather than maintaining status and command associations on a client these associations are published or configured at a presence service. When a presence tuple of a client 202 is updated with a new status, the presence service 204 determines the commands associated with the new status. For example, in FIG. 6, this is done by a command associator 602, which is included in a notification handler 604. The associations between commands and status are stored in this embodiment in a tuple data store 606. The command associator 602 queries the tuple data store 606 to determine if a command matches the new status. If a command does match the new status, a notification is generated for a watcher subscribed to the presentity's tuple. The subscription handler 608 receives subscription requests, and determines if a subscriber exists. If a subscriber exists, the generated notification will be sent to the subscriber via the message router 610 over the network 208 via a presence protocol layer 612 and a network stack 614. The message router 610 sends outgoing messages and routes incoming messages based on a command included in each incoming message.

In an embodiment, prior to sending out a notification, the command associator 602 uses the associations in the database 606 to determine if any commands are associated with the new status. The determination is made in a similar manner as described above in reference to the service state manager 312. If a command is associated with the status, then the command is included in the notification along with the new status information. In an embodiment where command requests are sent using a presence protocol, the presence service 204 validates that the command is processable by the target client by checking its status and the associated commands. Note that command validation is optional. The validation of commands is accomplished by a command validator 616 which is depicted as a component of a publication handler 618. In an embodiment, the command validator 616 is configured to enable a constraint mode using a presence server 204 to ensure commands not compatible with the status are sent not to the principal's watcher 320. In other embodiments, the command validator 616 resides in either the sending or the receiving client as well.

In an embodiment, the status update and the associated command information is received by the publication handler 618 which updates tuple data in the tuple data store 606. The publication handler 618 invokes at least one of the subscription handler 608 and the notification handler 604 to send the status and associated command information to a watching client such as the mobile phone 202B as already described. In an embodiment, a command selected on the mobile phone 202B as already described and sent to the presence service 204 via a presence protocol is received as a publish command and routed to the publication handler 618 as other publish messages are. It is the publication handler 618 that invokes the command validator 616, if present in the presence service 204. Command requests are processed as other publish commands where the publication handler 618 updates associated tuple data in 606 and invokes the subscription handler 608 or notification handler 604 to send the command request in a notify message to the watcher 320 acting a an agent for its principal, application 304 in the PC 202A.

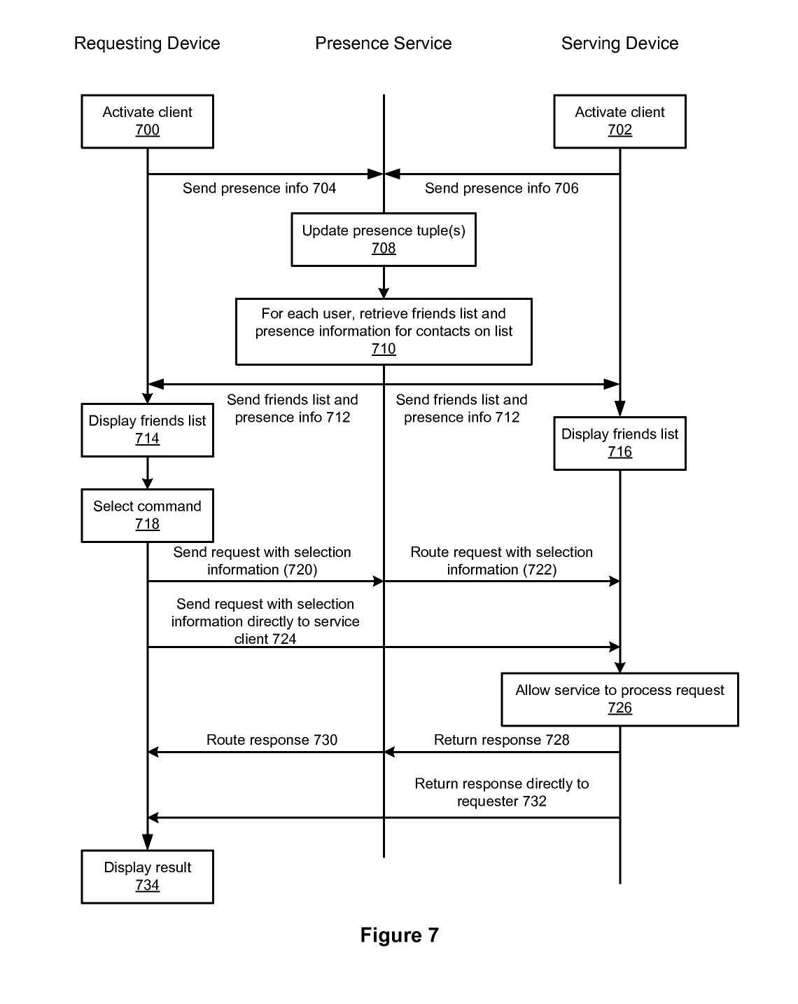

According to an aspect, a method for presenting command information associated with a status is described. FIG. 7 is a message flow diagram illustrating a flow of information in presenting command information associated with a status, according to an exemplary embodiment. The flow diagram illustrates two embodiments, one using a presence service to request commands be processed, and an embodiment that does not use the presence service. In FIG. 7, both a requesting device and a serving device come online simultaneously.

In blocks 700 and 702, the requesting device client and the serving device clients are activated. Both devices send presence information to the presence service at 704 and 706. The presence service updates the presence tuples of the two devices at block 708. For each user, a friends list is retrieved, the friends list including presence information and command information representing commands that can be processed by each the contacts on the list when having its current status at block 710.

The friends lists, with the associated presence information and command information, are sent to each device at 712. At blocks 714 and 716, each device displays its respective friends list. At block 718, the requesting device selects a command associated with the status of the serving device. In one embodiment, the request along with selection information is sent to the presence service at 720, the presence service then routes the request to the serving device at 722. In another embodiment, the request along with selection information is sent directly to the serving device at 724. In both embodiments, the serving device allows a service to process the request at block 726. After the request is processed, a response is returned to the requesting device. In one embodiment, the response is sent to the presence service at 728, the presence service then routes the request to the requesting device at 730. The requesting device then displays the result at block 706. In one embodiment, the response is sent directly to the requesting device at 732. In either case, the result is displayed at block 734 in the example.

The executable instructions of a computer program as illustrated in FIG. 1 for presenting command information associated with a status can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for presenting command information associated with a status, the method comprising:
associating a command with a status of a presentity for indicating a principal associated with the presentity can process the command when the presentity has the associated status;
determining a change in status associated with the presentity;
determining whether the changed status corresponds to the status associated with the command; and
sending a status message to a client including a watcher via a presence service, the status message including the changed status of the presentity and command information related to the command when the changed status corresponds to the status associated with the command, allowing the client including the watcher to request the principal to process the command.

2. The method of claim 1 wherein the command information includes constraint information for restricting commands not associated with the changed status of the presentity from being processed.

3. The method of claim 1 wherein the command information includes deactivation information associated with a deactivating command for deactivating the principal associated with the presentity.

4. The method of claim 1 wherein the command associated with the status of the presentity includes a configuration command for allowing the principal associated with the presentity to be configured.

5. The method of claim 1 wherein the command information includes access information providing a permission for requesting a command to be processed.

6. The method of claim 1 comprising receiving association information representing the association between the command and the status of the presentity.

7. The method of claim 6 comprising updating the association between the command and the status of the presentity according to the association information.

8. The method of claim 6 comprising establishing the association of the command with the status of the presentity according to the association information.

9. The method of claim 1 comprising receiving a request including selection information based on the command information of a command selected for processing, the selection information identifying the selected command.

10. The method of claim 9 comprising processing the command according to the selection information.

11. The method of claim 1 wherein sending the status message comprises sending a directed notification to the client including the watcher.

12. The method of claim 1 comprising receiving a subscription request from the client including the watcher, the subscription request including identification information representing the watcher.

13. The method of claim 11 comprising:
associating a plurality of commands with the status of the presentity for indicating a principal associated with the presentity can process any of the plurality of commands when the presentity has the associated status; and
selecting one of the plurality of commands associated with the status of the presentity according to the identification information of the watcher to include command information related to the selected command in the status message when the changed status corresponds to the status associated with the plurality of commands.

14. The method of claim 1 wherein determining a change in status associated with the presentity occurs via the presence service.

15. The method of claim 1 wherein the status message includes form information for presenting a form to a principal associated with the client including the watcher, the form for receiving parameters associated with the command information.

16. A method for presenting command information associated with a status, the method comprising:
transmitting a subscription request to a presence service, the subscription request for subscribing to a tuple associated with a presentity;
receiving a status message via the presence service in response to a change in status of the presentity, the status message including the changed status of the presentity and command information related to a command indicating a principal associated with the presentity can process the command; and
transmitting a selection message including a selection of the command for the presentity to process.

17. The method of claim 16 comprising receiving a response including a result associated with the selection of the command for the presentity to process.

18. The method of claim 17 comprising displaying the result in response to receiving the response.

19. A system for presenting command information associated with a status, the system comprising:
a presentity associated with a presence service; and
a service state manager configured to associate a command with a status of the presentity for indicating a principal associated with the presentity can process the command when the presentity has the associated status, determine a change in status of the presentity, and determine whether the changed status corresponds to the status associated with the command;
wherein the presentity is configured to send a status message to a client including a watcher associated with the presence service via the presence service, the status message including the changed status of the presentity and command information related to the command when the changed status corresponds to the status associated with the command, allowing the client including the watcher to request the principal to process the command.

20. The system of claim 19 comprising a command handler configured to process a command if the presentity associated with the principal has a predetermined status.

21. The system of claim 19 comprising a state database configured to store the association of the command with the status of the presentity.

22. The system of claim 21 wherein the service state manager is configured to query the state database to determine whether the changed status corresponds to the status associated with the command.

23. The system of claim 19 wherein the command information includes constraint information for restricting commands not associated with the changed status of the presentity from being processed.

24. The system of claim 19 wherein the command associated with the status of the presentity includes a deactivating command for deactivating the principal associated with the presentity.

25. The system of claim 19 wherein the command associated with the status of the presentity includes a configuration command for allowing the principal associated with the presentity to be configured.

26. A computer readable medium containing a computer program, executable by a machine, for presenting command information associated with a status, the computer program comprising executable instructions for:
associating a command with a status of a presentity for indicating a principal associated with the presentity can process the command when the presentity has the associated status;
determining a change in status associated with the presentity;
determining whether the changed status corresponds to the status associated with the command; and
sending a status message to a client including a watcher via a presence service, the status message including the changed status of the presentity and command information related to the command when the changed in status corresponds to the status associated with the command, allowing the client including the watcher to request the principal to process the command.
